(19) United States
(12) Patent Application Publication
(10) Pub. No.: US 2016/0298388 A1
(43) Pub. Date: Oct. 13, 2016

(54) REEL-LINKING STRUCTURE AND LINKING COLLAR THEREOF

(71) Applicant: YI-CHIN TAO, KAOHSIUNG CITY (TW)

(72) Inventor: YI-CHIN TAO, KAOHSIUNG CITY (TW)

(21) Appl. No.: 14/684,623

(22) Filed: Apr. 13, 2015

(51) Int. Cl. E06B 9/68; B65H 75/44; E06B 9/44; B65H 75/12

(52) U.S. Cl. CPC E06B 9/68; B65H 75/12; B65H 75/446; E06B 9/44; E06B 2009/405

(57) ABSTRACT

A reel-linking structure and a linking collar thereof are disclosed. The reel-linking structure includes a mount, two reel connectors, and the linking collar. At least one of the two reel connectors is rotatably connected to the mount. The linking collar has two arms between which an encircled space is defined and configured to connect between the two reel connectors. The two arms are detachably assembled, so that the linking collar can be adjusted between an engaged position and a disengaged position. At the engaged position, the two reel connectors are motionally linked. At the disengaged position, the two reel connectors are motionally delinked.

### BACKGROUND OF THE INVENTION

1. Technical Field

The present invention relates to a reel-linking structure and a linking collar thereof, and more particularly, to a reel-linking structure which can link or delink plural reels by engaging or disengaging its linking collar.

2. Description of Related Art

A conventional roller blind has its two ends each supported by a brace that is equipped with a winder to roll the roller blind by controlling the roller blind to extend or retract. However, if it is the case that plural windows are continuously arranged, it is improper for the windows to each have an individual winder.

Therefore, reel-linking structures for roller blinds have been developed, such as the one disclosed in Taiwan Patent No. M304304. The prior-art device includes at least two reel caps and a fixing frame. Each of the reel caps has a linking block, and each of the linking blocks has a fixing member. The fixing members of two adjacent said reel caps are correspondingly coupled. Thus, by using a transmission, plural roller blind reels can be controlled at the same time.

However, in the prior-art approach, the reels cannot be individually detached or adjusted until the roller blind, the fixing frame, and the reel caps are all removed, so the assembly and installation are inconvenient. As an improvement, the inventor of the present invention has developed a reel-linking component for a roller blind and gotten it patented as Taiwan Patent No. M458907. Therein, two reel connectors are not coupled with each other. Instead, the two reel connectors have their linking portions combined by means of a connecting ring so as to form motional link therebetween. The connecting ring is rotatably connected to the fixing frame by means of a bush. Thus, by moving the connecting ring, it is possible to make the two reel connectors motionally linked or delinked with each other.

However, since the two reel connectors are rotatably fixed to the fixing frame by means of the connecting ring, the connecting ring and/or the bush are/is likely to have wear and deformation caused by overload, thereby making the product less durable.

### SUMMARY OF THE INVENTION

Hence, the present invention provides a reel-linking structure with improved durability. In one aspect of the present invention, the reel-linking structure includes a mount, two reel connectors, and a linking collar. The mount has at least one receiving hole. The two reel connectors each have one end provided with a linking portion, wherein the linking portions of the two reel connectors face each other and each include a first engaging segment; and at least one of the two reel connectors is rotatably received in the at least one receiving hole of the mount. The linking collar includes two arms between which an encircled space is defined and configured to fittingly receive the linking portions of the two reel connectors, wherein at least one of the two arms has a second engaging segment adjacent to the encircled space, and the two arms are detachably assembled and therefore enable the linking collar to be adjusted to an engaged position, where the second engages with segment engages the first engaging segments of the reel connectors.

In another aspect of the present invention, the reel-linking structure includes a mount, two reel connectors, and a linking collar. The two reel connectors each have a linking portion, wherein the linking portions of the two reel connectors face each other, and at least one of the two reel connectors has a bearing adjacent to its linking portion and is thereby rotatably mounted to the mount. The linking collar is mounted around the linking portions of the two reel connectors so as to be adjusted to an engaged position where the linking collar engages with the linking portions of the reel connectors.

In still another aspect of the present invention, a linking collar adapted to two reel connectors is provided, in which the two reel connectors each have one end provided with a linking portion. The linking portions of the two reel connectors face each other and each have a first engaging segment. The linking collar includes two arms, between which an encircled space is defined and configured to fittingly receive the linking portions of the two reel connectors. At least one of the two arms has a second engaging segment adjacent to the encircled space, and the two arms are configured to be adjusted to an engaged position where the second engaging segment engages with the first engaging segments of the reel connectors.

In some embodiments of any of the above aspect of the present invention, the reel connectors each have a displaceable extension rod having one end mounted with its linking portion.

One object of the present invention is to provide a reel-linking structure that its two reel connectors can be rotatably connected to the mount without the help of the linking collar so that its linking collar is protected from wear and deformation caused by overload, thereby making the product more durable.

Another object of the present invention is to provide a reel-linking structure in which the rolling or unrolling positions of its two reel connectors can be adjusted without disassembling the mount, so the product is more convenient to assemble.

Still another object of the present invention is to provide a reel-linking structure that the linking portion of its reel connector is extendable, so the reel connector can be detached from the mount without disassembling the mount, making the assembly of the product more convenient.

### BRIEF DESCRIPTION OF THE DRAWINGS

FIG. 1 is a perspective view of one embodiment of the present invention.

FIG. 2 is an exploded view of the embodiment of the present invention, showing that the mount, the reel connector, and the linking collar are separated from each other.

FIG. 3 is an exploded view of the reel connector of the embodiment of the present invention.

FIG. 4 is a cut-away view of the reel connector of the embodiment of the present invention.

FIG. 5 is a cross-sectional view of the embodiment of the present invention taken along Line V-V of FIG. 2.

FIG. 6 is a perspective view of the reel connector of the embodiment of the present invention, showing that the reel connector is in a retracted state.

FIG. 7 is a cross-sectional view of the reel connector of the embodiment of the present invention taken along Line VII-VII of FIG. 6.

FIG. 8 an applied, cross-sectional view of the embodiment of the present invention assembled with a roller blind.

FIG. 9 is a schematic drawing according to the embodiment of the present invention depicting that two roller blinds are at different unrolled lengths.

FIG. 10 is a schematic drawing according to the embodiment of the present invention depicting that two roller blinds are at the same unrolled length.

FIG. 11 is a schematic drawing according to the embodiment of the present invention illustrating the installation of the linking collar.

FIG. 12 is a cross-sectional view of the embodiment of the present invention wherein the linking collar has been installed.

FIG. 13 is another cross-sectional view of the embodiment of the present invention wherein the linking collar has been installed, showing the first engaging segment of the reel connector and the second engaging segment of the linking collar engage with each other.

### DETAILED DESCRIPTION OF THE INVENTION

The disclosed reel-linking structure and its technical features can be clearly understood by referring to the following embodiment(s).

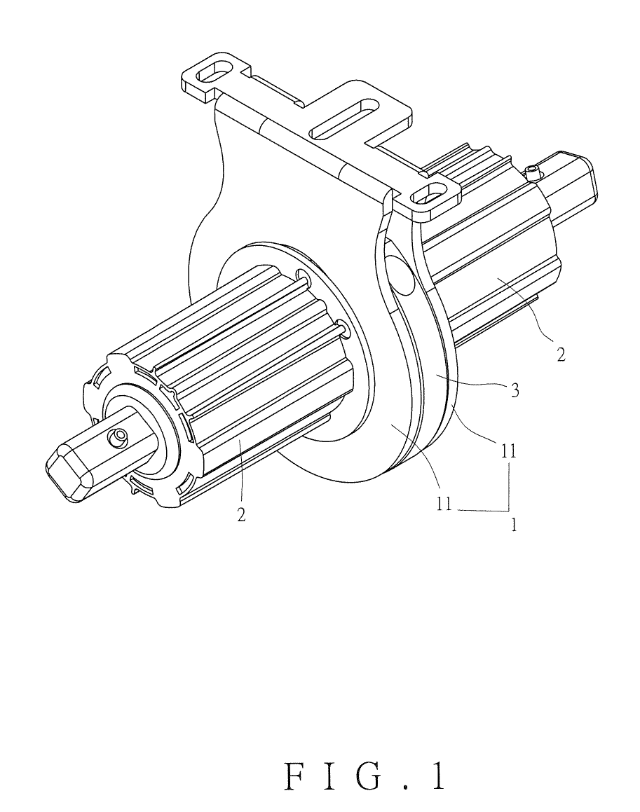

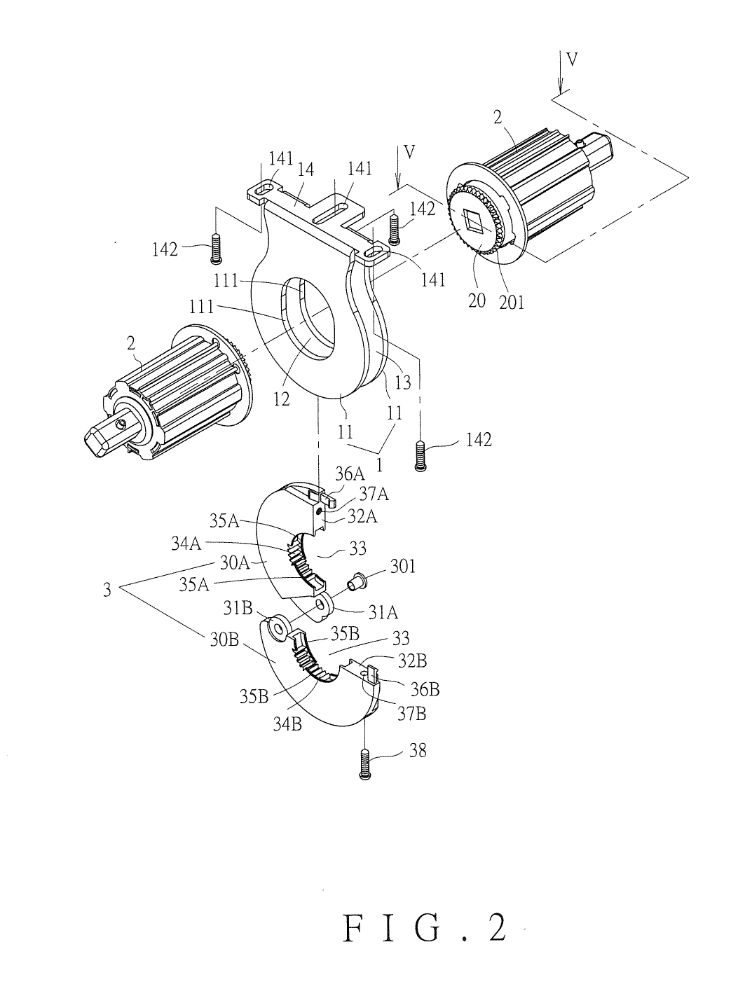

Referring to FIG. 1 and FIG. 2, according to an embodiment of the present invention, a reel-linking structure comprises a mount (1), two reel connectors (2), and a linking collar (3).

The mount (1) is configured to be fixed to a predetermined position (such as on a wall). The mount (1) has two aligned supporting plates (11). Each of the two supporting plates (11) has a receiving hole (111). Between the two supporting plates (11), there are defined an accommodating space (12) and a slot (13) communicated with the accommodating space (12). More particularly, the mount (1) is made by bending a single metal sheet into the two supporting plates (11) and a connecting plate (14) connecting the two supporting plates (11). The connecting plates (14) are provided with a plurality of fixing holes (141), so that the connecting plates (14) can be fixed to the predetermined position by using some fixing members (142) (such as screws) passing through the fixing holes (141).

Each of the two reel connectors (2) has one end provided with a linking portion (20) for allowing the two reel connectors (2) to be rotatably fitted into the two supporting plates (11) of the mount (1) such that the linking portions (20) of the two reel connectors (2) face each other and enter the accommodating space (12) of the mount (1). Each of the linking portions (20) may be but is not necessarily a toothed plate that has peripherally formed with a plurality of first engaging segments (201).

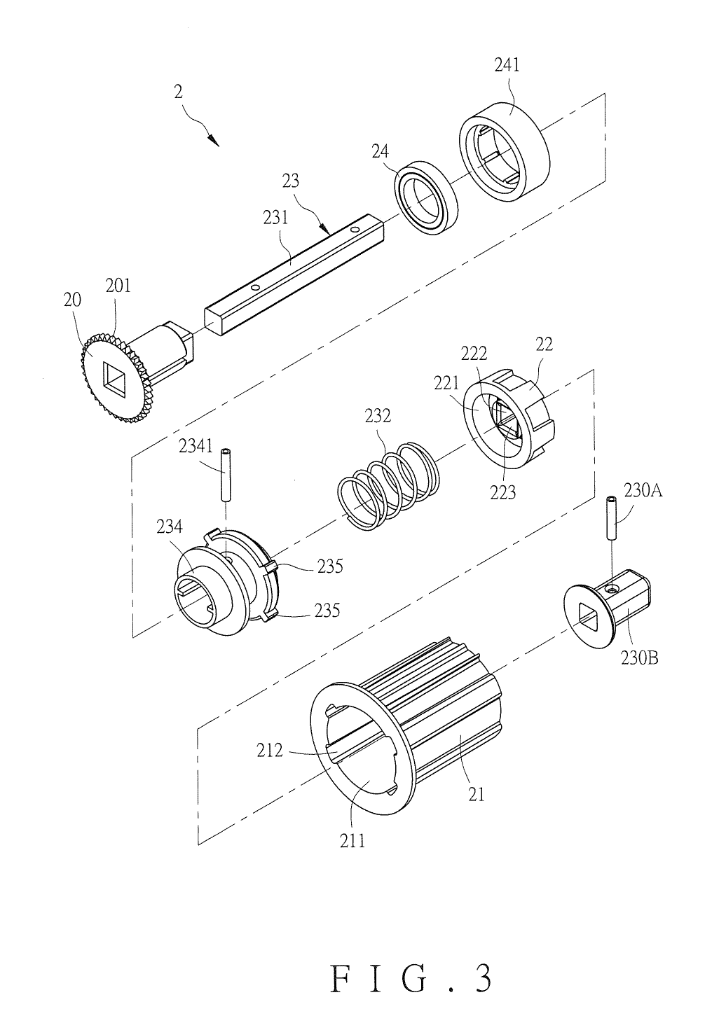

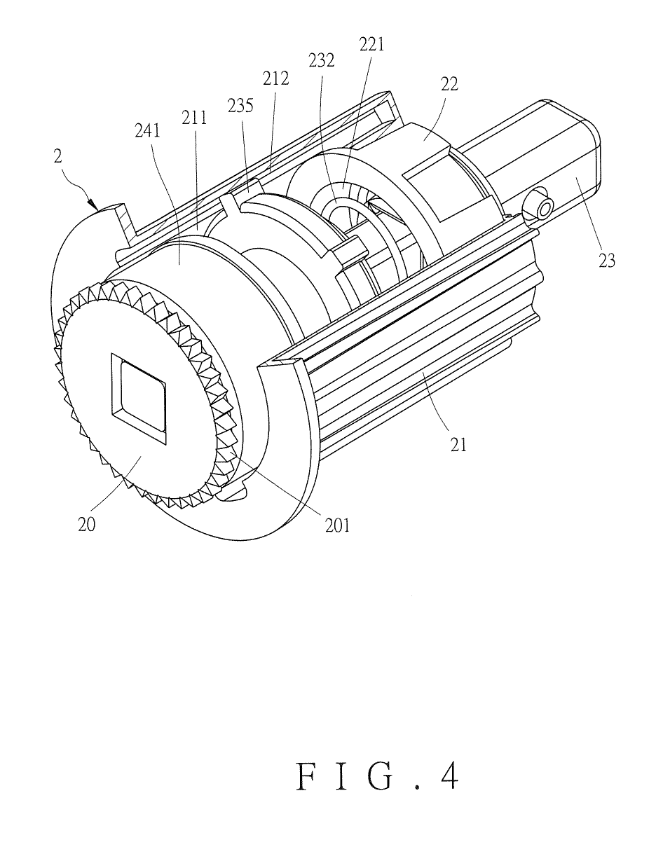

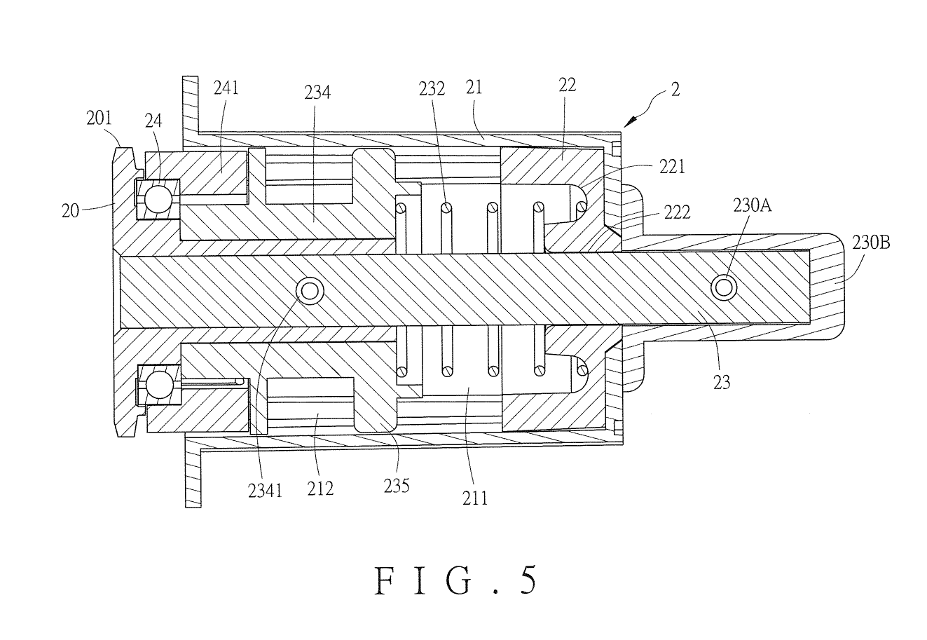

Referring to FIG. 3, FIG. 4, and FIG. 5, in detail, the reel connectors (2) each comprise a housing (21), an inner ring (22), an extension rod (23), and a bearing (24). Each housing (21) defines therein a room (211) having a first guiding portion (212) (such as a sliding groove) extending along the housing (21). Each inner ring (22) is installed into the room (211) of the corresponding housing (21), and has an outer periphery matching in contour with an inner periphery of the corresponding housing (21) so that the inner ring (22) and the corresponding housing (21) can engage with each other while the inner ring (22) has been installed into the room (211) of the corresponding housing (21). Each inner ring (22) has a recess (221) and an engaging hole (222) penetrating through the bottom of the recess (221) and having a non-circular section (such as a square section), thus making a wall of the inner ring (22) which faces the engaging hole (222) form a first retaining section (223).

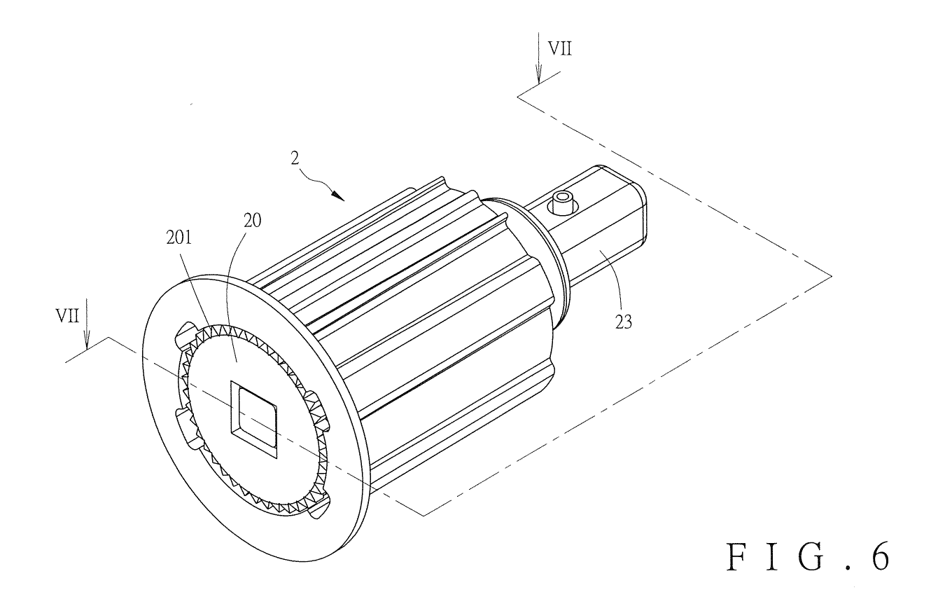

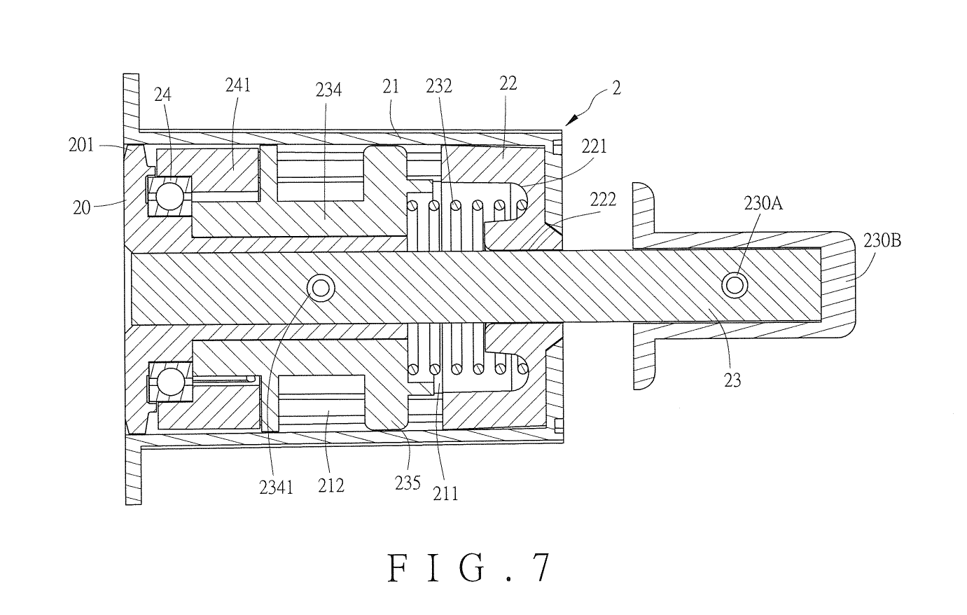

Referring to FIG. 6 in conjunction with FIG. 7, each extension rod (23) is movably received in the engaging hole (222) of the corresponding inner ring (22) and is therefore allowed to advance and retract with respect to the corresponding inner ring (22). Each extension rod (23) has a non-circular section (such as a square section). Each extension rod (23) is peripherally formed with a second retaining section (231), as shown more clearly in FIG. 3, for engaging with the first retaining section (223) of the corresponding inner ring (22), so that the extension rod (23) and the corresponding inner rings (22) can be driven to move while the corresponding housing (21) is rotated. Each extension rod (23) has one end mounted with the corresponding linking portion (20) (i.e. the toothed plate in the present embodiment), and has an opposite end passing through the corresponding inner ring (22) and being combined with a cover (230B) by means of a locking pin (230A). Thereby, the covers (230B) can abut against the inner rings (22) and prevent the extension rods (23) from separating from the inner rings (22) while the extension rods (23) is advanced with respect to the inner rings (22).

Each reel connector (2) has a spring member (232) located between the linking portion (20) and the recess (221) of the inner ring (22), so that the extension rod (23) of each reel connector (2) can returnably advance and retract with respect to the reel connector (2). Accordingly, the linking portions (20) can be retracted and depart from the receiving holes (111) so as to detach the reel connectors (2) from the mount (1) without disassembling the mount (1). Also, in case that the mount (1) has been fixed to the wall, the linking portions (20) of the reel connectors (2) can be easily mounted to the supporting plates (11) of the mount (1) while in a retraced state.

Preferably, each extension rod (23) is mounted with a support sleeve (234). Each support sleeve (234) is for example fixed to the corresponding extension rod (23) by a pin (2341). Each support sleeve (234) has a second guiding portion (235) (such as raised block) interacting with the first guiding portion (212) of the corresponding housing (21), so that with the support sleeve (234) mounted around, each extension rod (23) can be guided by the first guiding portion (212) of the corresponding housing (21) and performs advancing or retracting displacement, thereby making the corresponding linking portion (20) (i.e. the toothed plate in the present embodiment) protruded out of or retracted back to the corresponding housing (21). Each extension rod (23) is mounted with the bearing (24) and a bearing bush (241), in which the bearing (24) and the bearing bush (241) are located between the corresponding support sleeve (234) and the corresponding linking portion (20), and the bearing bush (241) is mounted around the bearing (24) and held in position by the corresponding support sleeve (234) and the corresponding linking portion (20). Thereby, the reel connectors (2) can be rotatably fitted into the receiving holes (111) of the supporting plates (11) by means of the bearings (24).

The linking collar (3) is mounted around the linking portions (20) of the two reel connectors (2). The linking collar (3) can be adjusted between an engaged position and a disengaged position. At the engaged position, the linking collar (3) engages with the linking portions (20) of the reel connectors (2). At the disengaged position, the linking collar (3) is disengaged from the linking portions (20) of the reel connectors (2). Thereby, the two reel connectors (2) can be selectively set as motionally linked or delinked with each other.

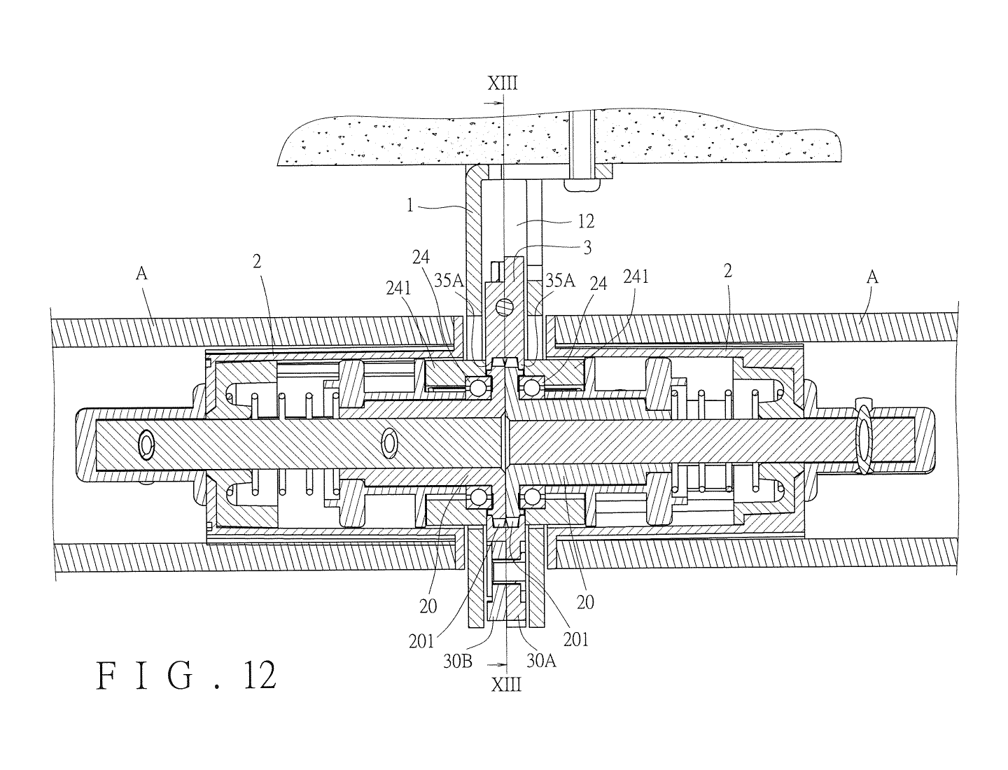

Referring back to FIG. 2, more particularly, the linking collar (3) comprises two arms (30A), (30B). The two arms (30A), (30B) each have a pivoting end (31A), (31B) and a combining end (32A), (32B) opposite to the pivoting end (31A), (31B). The pivoting ends (31A), (31B) of the two arms (30A), (30B) are pivotally connected by a pivot (301) (such as a rivet). When the linking collar (3) is at the engaged position, the two arms (30A), (30B) jointly define an encircled space (33) for fittingly receiving the linking portions (20) of the two reel connectors (2). The two arms (30A), (30B) each have plural second engaging segments (34A), (34B) adjacent to the encircled space (33) and corresponding to the linking portions (20) of the reel connectors (2). Preferably, the linking collar (3) has two retaining edges (35A), (35B) extending from the rim of the encircled space (33). The two retaining edges (35A), (35B) are configured to hold outer rims of the linking portions (20) of the two reel connectors (2) (as shown in FIG. 12), thereby retaining the linking portions (20) of the two reel connectors (2) between the two retaining edges (35A), (35B) and preventing displacement of the linking collar (3) with respect to the two reel connectors (2).

The combining ends (32A), (32B) of the two arms (30A), (30B) each have a buckle member (36A) or (36B) and a combining hole (37A) or (37B). When the linking collar (3) is at the engaged position, the buckle members (36A), (36B) of the two arms (30A), (30B) engage with each other and the combining holes (37A), (37B) of the two arms (30A), (30B) are aligned for a screw (38) to pass therethrough, thereby retaining the linking collar (3) at the engaged position. However, the combination between the combining ends (32A), (32B) of the two arms (30A), (30B) as described previously is for illustrative only, and the present invention is not limited thereto. Alternatively, the combination may be achieved by means of magnet or sucking plates, as along as the combining ends (32A), (32B) of the two arms (30A), (30B) can be detachably assembled.

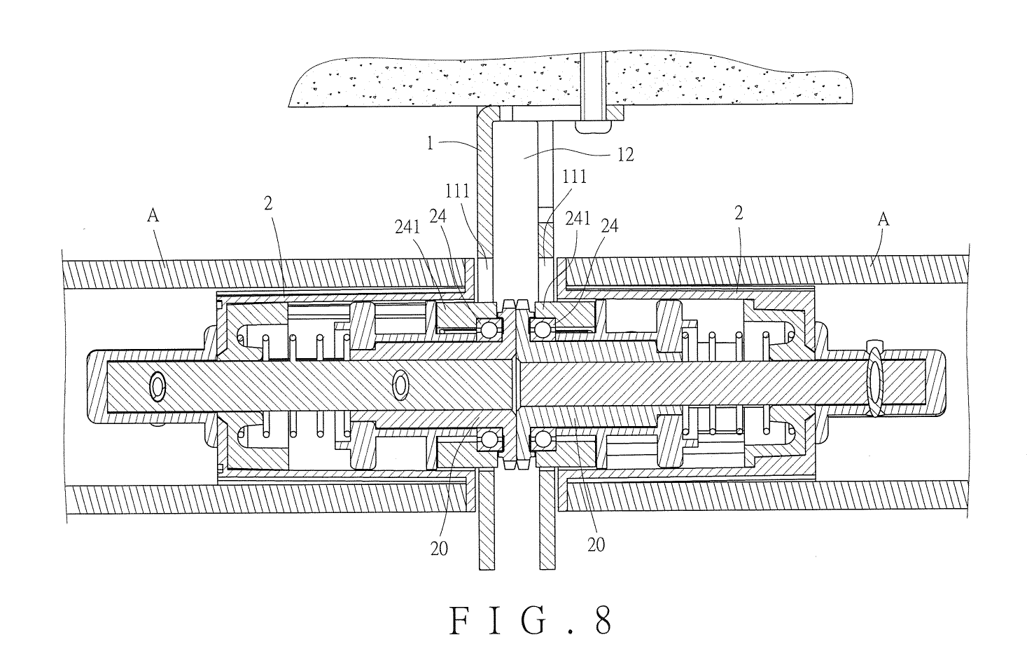

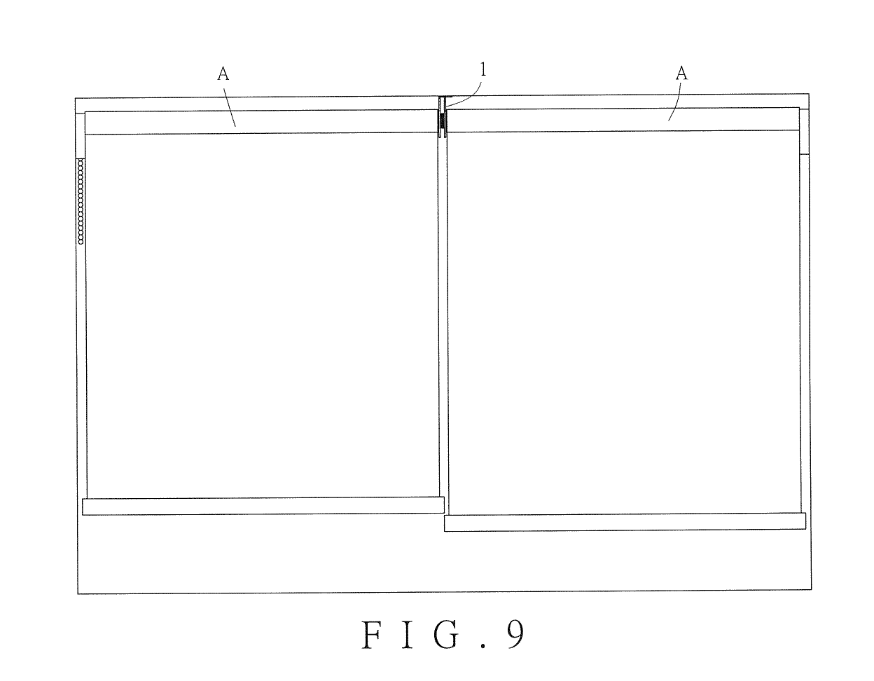

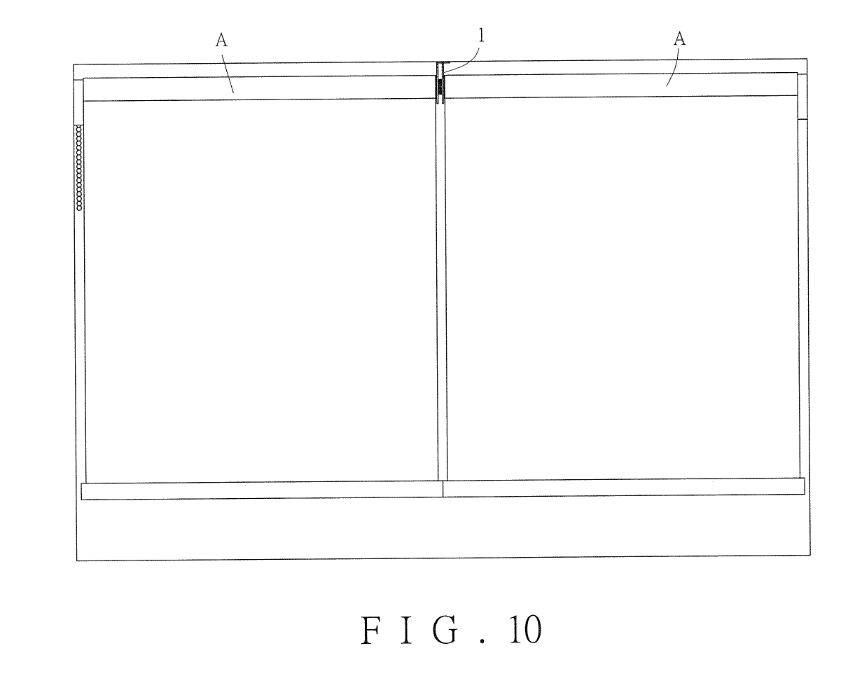

To assemble the structure, referring to FIG. 8, the two reel connectors (2) are rotatably fitted into the receiving holes (111) of the mount (1) with the help of the bearings (24) and the bearing bushes (241), so that the linking portions (20) of the two reel connectors (2) face each other. Each of the two reel connectors (2) has a free end assembled with a respective reel (A), so that the reels (A) are mounted onto a wall. In this state, as the two reel connectors (2) have not been motionally linked, the unrolled lengths of the reels (A) can be individually adjusted. For example, in case that the reels (A) at the two reel connectors (2) have different unrolled lengths (as shown in FIG. 9), the reels (A) can be freely rolled or unrolled to let the reels (A) attached to the two reel connectors (2) have the same unrolled length (as shown in FIG. 10). Accordingly, the rolling or unrolling positions of the two reel connectors (2) can be adjusted without disassembling the mount (1), so the product is more convenient to assemble.

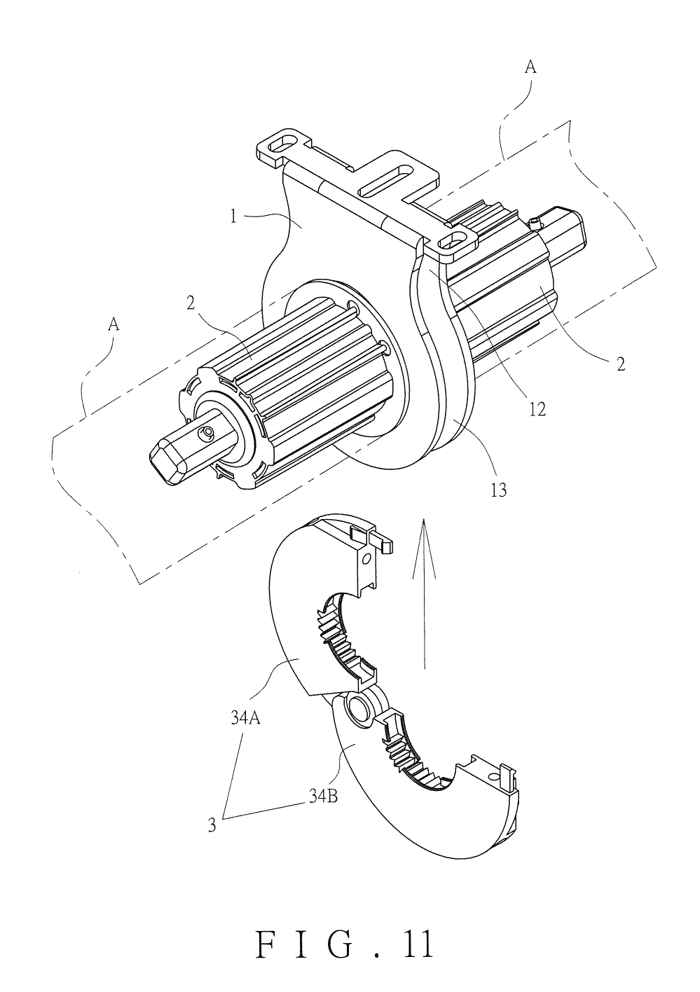

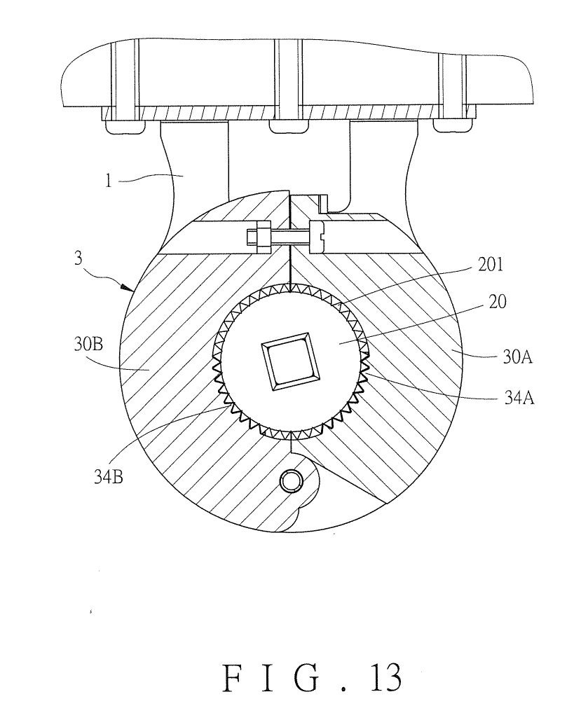

Referring to FIG. 11 and FIG. 12, then the linking collar (3) can be installed into the accommodating space (12) through the slot (13) of the mount (1), and mounted around the linking portions (20) of the two reel connectors (2) so that the first engaging segments (201) of the linking portions (20) of the two reel connectors (2) engage with the second engaging segments (34A), (34B) of the arms (30A), (30B) of the linking collar (3) (also referring to FIG. 13), thereby making the two reel connectors (2) motionally linked. In use, since the two reel connectors (2) are each rotatably fitted into the mount (1) through their respective bearings (24), the linking collar (3) is protected from wear and deformation caused by overload.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A reel-linking structure, comprising:
a mount, having at least one receiving hole;
two reel connectors, each having one end provided with a linking portion, wherein the linking portions of the two reel connectors face each other and each include a first engaging segment, and at least one of the two reel connectors is rotatably received in the at least one receiving hole of the mount; and
a linking collar, comprising two arms between which an encircled space is defined and is configured to fittingly receive the linking portions of the two reel connectors,
wherein at least one of the two arms has a second engaging segment adjacent to the encircled space, and the two arms are detachably assembled and therefore enable the linking collar to be adjusted to an engaged position, where the second engaging segment engages with the first engaging segments of the reel connectors.

2. The reel-linking structure of claim 1, wherein the two arms each have a pivoting end and a combining end opposite to the pivoting end, the pivoting ends of the two arms are pivotally connected to each other and able to swing relatively so as to adjust the linking collar from the engaged position to a disengaged position, where the second engaging segment is disengaged from the first engaging segments of the reel connectors.

3. The reel-linking structure of claim 2, wherein the combining end of each of the two arms is provided with a buckle member and a combining hole, and wherein while the linking collar is adjusted to the engaged position, the buckle members of the two arms engage with each other and the combining holes of the two arms are aligned for a screw to pass therethrough, thereby retaining the linking collar at the engaged position.

4. The reel-linking structure of claim 1, wherein the mount includes two aligned supporting plates each having one said receiving hole; one of the reel connectors is rotatably received in the receiving hole of one of the supporting plates by means of a bearing, while the other one of the reel connectors is rotatably received in the receiving hole of the other one of the supporting plates by means of another bearing; and between the two supporting plates there are an accommodating space and a slot communicated with the accommodating space, so that the linking collar is allowed to be installed into the accommodating space through the slot.

5. The reel-linking structure of claim 4, wherein the linking collar has two opposite retaining edges retaining the linking portions of the two reel connectors therebetween.

6. The reel-linking structure of claim 4, wherein each of the reel connectors comprises a displaceable extension rod, and each of the extension rods has one end mounted with one of the linking portions.

7. The reel-linking structure of claim 6, wherein each of the reel connectors further comprises a housing, an inner ring, and a spring member, in which each of the inner rings is fixedly installed into a corresponding said housing and has a first retaining section; each of the extension rods is movably connected to, and has a second retaining section configured to engage with the first retaining section of, a corresponding said inner ring; each of the spring members is provided between a corresponding said inner ring and a corresponding said linking portion; and each of the bearing is mounted around a corresponding said extension rod.

8. The reel-linking structure of claim 7, wherein the housing of each said reel connector has therein a first guiding portion, and the extension rod of each said reel connector is provided with a second guiding portion able to be guided by the first guiding portion of a corresponding said housing to perform advancing or retracting displacement.

9. A reel-linking structure, comprising:
a mount;
two reel connectors, each having a linking portion, wherein the linking portions of the two reel connectors face each other, and at least one of the two reel connectors has a bearing adjacent to its said linking portion and is thereby rotatably mounted to the mount; and
a linking collar, being mounted around the linking portions of the two reel connectors, for moving to an engaged position where the linking collar engages with the linking portions of the reel connectors.

10. A linking collar adapted to two reel connectors, the two reel connectors each having one end provided with a linking portion, the linking portions of the two reel connectors facing each other, the linking portions each having a first engaging segment, and the linking collar comprising:
two arms, between which an encircled space is defined and configured to fittingly receive the linking portions of the two reel connectors, wherein at least one of the two arms has a second engaging segment adjacent to the encircled space, and the two arms are configured to relatively move to an engaged position where the second engaging segment engages with the first engaging segments of the reel connectors.
